(19) United States
(12) Patent Application Publication
(10) Pub. No.: US 2024/0266605 A1
(43) Pub. Date: Aug. 8, 2024

(54) NON-AQUEOUS ELECTROLYTE SECONDARY BATTERY

(71) Applicant: Prime Planet Energy & Solutions, Inc., Tokyo (JP)

(72) Inventors: Yoshikazu MIYACHI, Kobe-shi (JP); Hideaki FUJITA, Kyotanabe-shi (JP); Daisuke NISHIDE, Kobe-shi (JP)

(21) Appl. No.: 18/413,026

(22) Filed: Jan. 16, 2024

(30) Foreign Application Priority Data
Jan. 30, 2023 (JP) 2023-011622

(51) Int. Cl. H01M 10/0567; H01M 10/0568

(52) U.S. Cl. CPC H01M 10/0567; H01M 10/0568; H01M 2300/0017

(57) ABSTRACT

The present disclosure relates to a non-aqueous electrolyte secondary battery, wherein an electrolyte solution includes a solvent, a lithium salt, and an additive agent, the additive agent includes at least one selected from a group consisting of a boron compound having an oxalate group and a compound having a fluorosulfonyl group, a BET specific surface area of a negative electrode active material layer is 1.8 m²/g or more and 3.0 m²/g or less, the negative electrode active material layer includes a particle group consisting of a negative electrode active material particle, an average sphericity of the particle group is 0.87 or more.

### CROSS REFERENCE TO RELATED APPLICATIONS

This nonprovisional application is based on Japanese Patent Application No. 2023-011622 filed on Jan. 30, 2023 with the Japan Patent Office, the entire contents of which are hereby incorporated by reference.

### BACKGROUND OF THE INVENTION

### Field of the Invention

The present disclosure relates to a non-aqueous electrolyte secondary battery (hereinafter also referred to as a battery).

### Description of the Background Art

Each of Japanese Patent Laying-Open No. 2007-179883 and WO 2014/157591 discloses an additive agent used in an electrolyte solution in order to suppress an increase in reaction resistance of a non-aqueous electrolyte secondary battery.

### SUMMARY OF THE INVENTION

Even in the case where the additive agent described in each of Japanese Patent Laying-Open No. 2007-179883 and WO 2014/157591 is used in the electrolyte solution of the non-aqueous electrolyte secondary battery, when the width of an electrode assembly is increased in order to improve a battery capacity per volume (hereinafter also referred to as a volume capacity), the reaction resistance may become high in a central portion of the electrode assembly, with the result that a battery property may be decreased. This is presumably due to the following reason: since permeation of the additive agent into the central portion of the electrode assembly is slower than that of a solvent or lithium salt of the electrolyte solution, an amount of a protective coating film formed by the additive agent in the central portion of the electrode assembly is smaller than that at an end portion of the electrode assembly, with the result that the resistance in the central portion of the electrode assembly is likely to be increased.

It is an object of the present disclosure to provide a non-aqueous electrolyte secondary battery so as to maintain a volume capacity and suppress an increase in reaction resistance of a central portion of an electrode assembly.

The present invention provides the following non-aqueous electrolyte secondary battery.
[1] A non-aqueous electrolyte secondary battery comprising an electrode assembly and an electrolyte solution, wherein
the electrode assembly includes a positive electrode plate, a negative electrode plate, and a separator,
the electrolyte solution includes a solvent, a lithium salt, and an additive agent,
the additive agent includes at least one selected from a group consisting of a boron compound having an oxalate group and a compound having a fluorosulfonyl group,
the negative electrode plate includes a negative electrode core member and a negative electrode active material layer including a negative electrode active material particle,
a BET specific surface area of the negative electrode active material layer is 1.8 m²/g or more and 3.0 m²/g or less,
the negative electrode active material layer includes a particle group consisting of the negative electrode active material particle, and an average sphericity of the particle group is 0.87 or more,
the electrode assembly is a wound type electrode assembly or a stacked type electrode assembly,
when the electrode assembly is the wound type electrode assembly, a length of the negative electrode active material layer in a direction parallel to a winding axis direction of the electrode assembly is 180 mm or more, and
when the electrode assembly is the stacked type electrode assembly, a shortest distance between at least one set of opposing end portions in the negative electrode active material layer as viewed in a stacking direction is 180 mm or more.
[2] The non-aqueous electrolyte secondary battery according to [1], wherein a size of the electrode assembly in a width direction of the electrode assembly is 300 mm or less.
[3] The non-aqueous electrolyte secondary battery according to [1] or [2], wherein a content of the additive agent in the electrolyte solution is 0.001 mass % or more and 10 mass % or less.
[4] The non-aqueous electrolyte secondary battery according to any one of [1] to [3], wherein an average particle size D50 of the particle group is 10 μm or more and 30 μm or less.
[5] The non-aqueous electrolyte secondary battery according to any one of [1] to [4], wherein the average sphericity is 0.9 or more.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an exemplary configuration of a non-aqueous electrolyte secondary battery in the present embodiment.

FIG. 2 is a schematic diagram showing an exemplary configuration of the electrode assembly in the present embodiment.

FIG. 3 is a schematic cross sectional view showing an exemplary configuration of the electrode assembly in the present embodiment.

FIG. 4 is a schematic diagram showing an exemplary configuration of the electrode assembly in the present embodiment.

FIG. 5 is a schematic diagram showing a layer configuration of a stack produced in an Example.

FIG. 6 is a schematic diagram illustrating a sample used for evaluation on reaction resistance in the Example.

### DESCRIPTION OF THE PREFERRED EMBODIMENTS

Hereinafter, embodiments of the present invention will be described with reference to figures, but the present invention is not limited to the below-described embodiments. In each of all the figures described below, a scale is appropriately adjusted to facilitate understanding of each component, and the scale of each component shown in the figures does not necessarily coincide with the actual scale of the component.

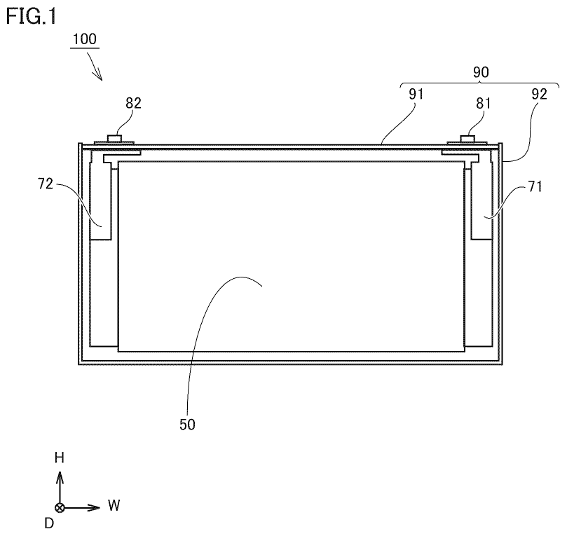

FIG. 1 is a schematic diagram showing an exemplary configuration of a non-aqueous electrolyte secondary battery in the present embodiment. A battery 100 may be used in any application. Battery 100 may be used as a main electric power supply or a motive power assisting electric power supply in an electrically powered vehicle or the like, for example. A battery module or a battery assembly may be formed by connecting a plurality of batteries 100. Battery 100 may have a rated capacity of, for example, 1 to 200 Ah.

Battery 100 includes an exterior package 90. Exterior package 90 has a prismatic shape (flat rectangular parallelepiped shape). Exterior package 90 may be composed of, for example, an aluminum (Al) alloy. Exterior package 90 stores an electrode assembly 50 and an electrolyte solution (not shown). That is, battery 100 includes electrode assembly 50 and the electrolyte solution.

Exterior package 90 may include, for example, a sealing plate 91 and an exterior container 92. Sealing plate 91 closes an opening of exterior container 92. For example, sealing plate 91 and exterior container 92 may be joined to each other by laser processing or the like. It should be noted that exterior package 90 may have any shape. Exterior package 90 may have, for example, a pouch shape or the like. That is, exterior package 90 may be a pouch composed of an Al laminate film or the like.

A positive electrode terminal 81 and a negative electrode terminal 82 are provided on sealing plate 91. Sealing plate 91 may be further provided with an injection opening (not shown), a gas-discharge valve (not shown), and the like. The electrolyte solution can be injected from the injection opening to inside of exterior package 90. The injection opening can be closed by, for example, a sealing plug or the like. A positive electrode current collecting member 71 connects positive electrode terminal 81 and electrode assembly 50. Positive electrode current collecting member 71 may be, for example, an Al plate or the like. A negative electrode current collecting member 72 connects negative electrode terminal 82 and electrode assembly 50. Negative electrode current collecting member 72 may be, for example, a copper (Cu) plate or the like.

Electrode assembly 50 includes a positive electrode plate, a separator, and a negative electrode plate. Electrode assembly 50 may be, for example, a wound type or a stacked type. When electrode assembly 50 is the wound type, electrode assembly 50 may be, for example, a stack of the positive electrode plate, the negative electrode plate, and the separator with a strip-like planar shape. The stack with the strip-like shape is spirally wound, thereby forming a wound assembly. The wound assembly may have a tubular shape, for example. By compressing the wound assembly having the tubular shape in the radial direction, electrode assembly 50 having a flat shape can be formed. The size of electrode assembly 50 in the width direction (W axis direction in FIG. 1) may be, for example, 300 mm or less, and may be 180 mm or more and 300 mm or less.

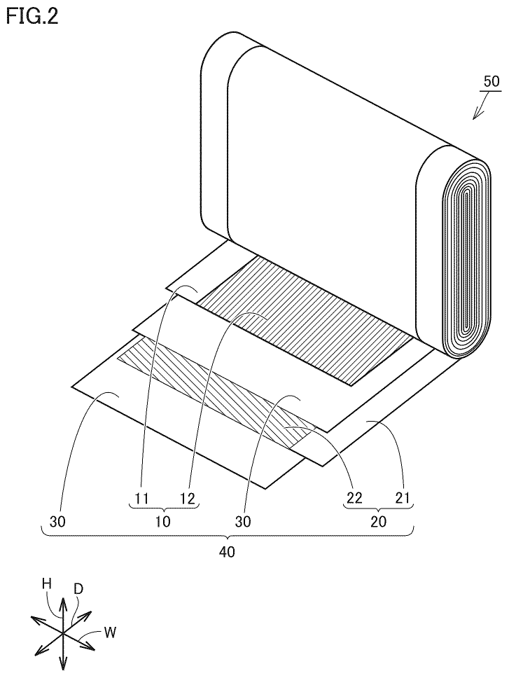

FIG. 2 is a schematic diagram showing an exemplary configuration of the electrode assembly in the present embodiment. Electrode assembly 50 shown in FIG. 2 is a wound type electrode assembly having a winding axis parallel to the W axis direction. Electrode assembly 50 includes a stack 40. Electrode assembly 50 may consist essentially of stack 40. Stack 40 includes a positive electrode plate 10, a negative electrode plate 20, and a separator 30. At least a portion of separator 30 is interposed between positive electrode plate 10 and negative electrode plate 20. Separator 30 separates positive electrode plate 10 and negative electrode plate 20 from each other. Stack 40 may include one separator 30 solely. Stack 40 may include two separators 30. For example, positive electrode plate 10 may be sandwiched between two separators 30. For example, negative electrode plate 20 may be sandwiched between two separators 30. Stack 40 may be formed by stacking separator 30 (first separator), negative electrode plate 20, separator 30 (second separator), and positive electrode plate 10 in this order, for example.

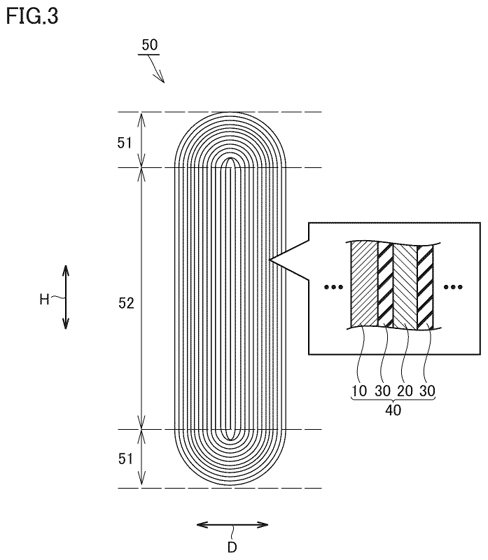

FIG. 3 is a schematic cross sectional view showing an exemplary configuration of the electrode assembly in the present embodiment. Electrode assembly 50 of FIG. 3 is the wound type electrode assembly. FIG. 3 shows a cross section orthogonal to a winding axis. Electrode assembly 50 includes curved portions 51 and a flat portion 52. At each of curved portions 51, stack 40 is curved. At curved portion 51, stack 40 may be in the form of an arc. At flat portion 52, stack 40 is flat. Flat portion 52 is sandwiched between two curved portions 51. Flat portion 52 connects two curved portions 51 to each other. The thickness of stack 40 represents the total of the thicknesses of positive electrode plate 10, negative electrode plate 20 and separator 30 included in stack 40. Stack 40 may have a thickness of 100 to 200 μm or may have a thickness of 1 to 100 mm, for example.

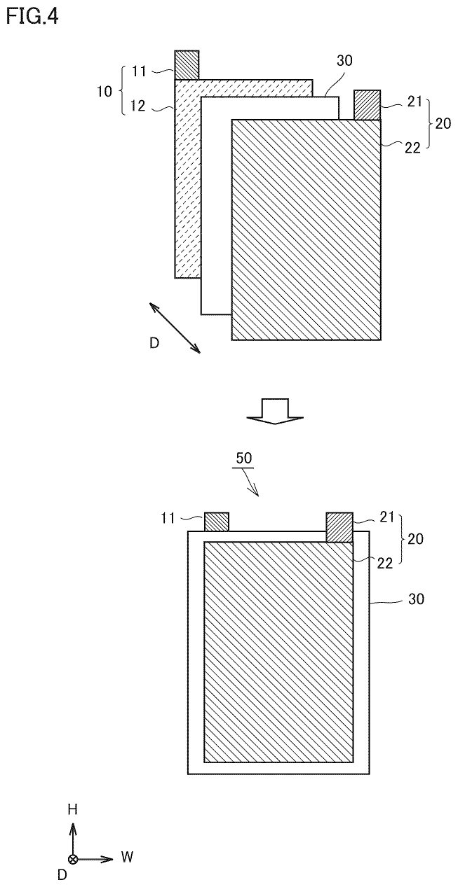

FIG. 4 is a schematic cross sectional view showing an exemplary configuration of the electrode assembly in the present embodiment. Electrode assembly 50 of FIG. 4 is the stacked type electrode assembly. When electrode assembly 50 is the stacked type, electrode assembly 50 may be a stack of the positive electrode plate, the negative electrode plate, and the separator with a quadrangular planar shape. As shown in FIG. 4, electrode assembly 50 can be formed by stacking a plurality of the stacks in one predetermined direction (D axis direction). Stacked type electrode assembly 50 consists essentially of the above-described flat portion of stack 40. The stacked type electrode assembly may have a thickness of 100 to 200 μm or may have a thickness of 1 to 100 mm, for example.

In electrode assembly 50, positive electrode plate 10 may have any number of layers. The number of the layers of positive electrode plate 10 represent the number of times a straight line extending across electrode assembly 50 in a layering direction intersects positive electrode plate 10. The layering direction represents a direction in which positive electrode plate 10, negative electrode plate 20, and separator 30 are layered in electrode assembly 50. The layering direction in electrode assembly 50 of the wound type is parallel to the thickness direction (D axis direction in FIG. 3) of each of positive electrode plate 10, negative electrode plate 20, and separator 30 in flat portion 52. The layering direction in electrode assembly 50 of the wound type is parallel to the thickness direction (D axis direction in FIG. 4) of each of positive electrode plate 10, negative electrode plate 20, and separator 30.

The number of the layers of positive electrode plate 10 may be 2 to 100, for example. The number of layers of negative electrode plate 20 may be 2 to 100, for example. The number of layers of separator 30 may be 4 to 200, for example. The number of the layers of negative electrode plate 20 and the number of the layers of separator 30 can be also counted in the same manner as the number of the layers of positive electrode plate 10. It should be noted that when electrode assembly 50 is the stacked type, the number of the layers of positive electrode plate 10, the number of the layers of negative electrode plate 20, and the number of the layers of separator 30 represent the number of positive electrode plates 10, the number of negative electrode plates 20, and the number of separators 30, respectively.

In FIG. 1, when electrode assembly 50 is the wound type electrode assembly, the length of the negative electrode active material layer in a direction parallel to the winding axis direction (W axis direction) of electrode assembly 50 is 180 mm or more, may be, for example, 200 mm or more or 220 mm or more, and may be 300 mm or less. In FIG. 1, when electrode assembly 50 is the stacked type electrode assembly, a shortest distance between at least one set of opposing end portions in the negative electrode active material layer as viewed in the stacking direction (D axis direction) is 180 mm or more, may be, for example, 200 mm or more or 220 mm or more, and may be 300 mm or less. When the stacked type electrode assembly has a rectangular shape as viewed in the stacking direction, the shortest distance is a shorter one of distances between sets of opposing end portions. In FIG. 4, the shortest distance is a distance in the W axis direction.

Positive electrode plate 10 includes a positive electrode core member 11 and a positive electrode active material layer 12 (see FIG. 2). Positive electrode core member 11 is an electrically conductive sheet. Positive electrode core member 11 may include, for example, a pure Al foil, a Al alloy foil, or the like. Positive electrode core member 11 may have a thickness of, for example, 10 to 30 μm. When electrode assembly 50 is the wound type electrode assembly, the positive electrode core member 11 may be exposed at one end in the width direction (W axis direction in FIG. 2) of electrode assembly 50. When electrode assembly 50 is the stacked type electrode assembly, positive electrode core member 11 may be exposed at one end in a direction (H axis direction in FIG. 4) perpendicular to the width direction of electrode assembly 50. Positive electrode current collecting member 71 can be joined to the exposed portion of positive electrode core member 11 (see FIG. 1).

Positive electrode active material layer 12 may be disposed only on one surface of positive electrode core member 11. Positive electrode active material layer 12 may be disposed on each of the front and rear surfaces of positive electrode core member 11. When electrode assembly 50 is the wound type, the thickness of positive electrode active material layer 12 represents the total of the thickness(es) of positive electrode active material layer(s) 12 included in stack 40. When electrode assembly 50 is the stacked type, the thickness of positive electrode active material layer 12 represents the total of the thickness(es) of positive electrode active material layer(s) 12 included in electrode assembly 50. For example, when positive electrode active material layers 12 are formed on the both surfaces of positive electrode plate 10, the thickness of positive electrode active material layer 12 represents the total of the thicknesses of positive electrode active material layers 12 on the both surfaces (two surfaces) thereof. Positive electrode active material layer 12 may have a thickness of 100 μm or more and 260 μm or less, may have a thickness of 20 to 60 μm, or may have a thickness of 30 to 50 μm, for example. It should be noted that the thickness of positive electrode active material layer 12 on one surface thereof may be 10 to 30 μm or may be 15 to 25 μm, for example.

Positive electrode active material layer 12 includes positive electrode active material particles. Each of the positive electrode active material particles can include any component. Each of the positive electrode active material particles may include, for example, at least one selected from a group consisting of LiCoO₂, LiNiO₂, LiMnO₂, LiMn₂O₄, Li(NiCoMn)O₂, Li(NiCoAl)O₂, and LiFePO₄. For example, in a composition formula such as “Li(NiCoMn)O₂”, the total of the composition ratios in the parentheses is 1. That is, the relation “C_{Ni}+C_{Co}+C_{Mn}=1” is satisfied. For example, “C_{Ni}” represents a composition ratio of Ni. Any composition ratio of each component is employed as long as the total of the composition ratios is 1.

Positive electrode active material layer 12 may further include a conductive material, a binder, an additive agent, and the like in addition to the positive electrode active material particles. For example, positive electrode active material layer 12 may consist essentially of 0.1 to 10% of the conductive material in mass fraction, 0.1 to 10% of the binder in mass fraction, and a remainder of the positive electrode active material particles. The conductive material may include, for example, acetylene black or the like. The binder can include any component. The binder may include, for example, polyvinylidene difluoride (PVdF) or the like. Details of the additive agent will be described later.

Separator 30 includes a porous resin layer. Separator 30 may consist essentially of a porous resin layer. The porous resin layer is in direct contact with negative electrode active material layer 22. Since no object is interposed between the porous resin layer and negative electrode active material layer 22, it is expected to attain an improved output or the like, for example. It should be noted that separator 30 may or may not include a protective layer on its surface to be in contact with positive electrode active material layer 12.

The porous resin layer may have a thickness of 10 to 50 μm, may have a thickness of 10 to 30 μm, or may have a thickness of 14 to 20 μm, for example.

The porous resin layer has an electrical insulation property. The porous resin layer includes a polyolefin-based material. The porous resin layer may consist essentially of the polyolefin-based material, for example. The polyolefin-based material may include, for example, at least one selected from a group consisting of polyethylene (PE) and polypropylene (PP).

Negative electrode plate 20 includes a positive electrode core member 21 and a negative electrode active material layer 22 (see FIG. 2). Negative electrode active material layer 22 may be disposed on a surface of negative electrode core member 21. Negative electrode active material layer 22 may be disposed only on one surface of negative electrode core member 21. Negative electrode active material layer 22 may be disposed on each of both front and rear surfaces of negative electrode core member 21. Negative electrode core member 21 is an electrically conductive sheet. Negative electrode core member 21 may include, for example, a pure Cu foil, a Cu alloy foil, or the like. Negative electrode core member 21 may have a thickness of, for example, 5 to 30 μm. When electrode assembly 50 is the wound type electrode assembly, negative electrode core member 21 may be exposed at one end portion in the width direction of negative electrode plate 20 (W axis direction in FIG. 2). When electrode assembly 50 is the stacked type electrode assembly, negative electrode core body 21 may be exposed at one end portion in the direction (H axis direction in FIG. 4) perpendicular to the width direction of electrode assembly 50. Negative electrode current collecting member 72 can be joined to the exposed portion of negative electrode core member 21 (see FIG. 1).

A BET specific surface area (hereinafter also referred to as an electrode plate BET) of negative electrode active material layer 22 is 1.8 m²/g or more and 3.0 m²/g or less. When the electrode plate BET is made small, the surface into and out of which lithium comes is reduced to result in increased reaction resistance; however, when a specific additive agent is included in the electrolyte solution, reaction resistance in a central portion of the electrode assembly tends to be conversely increased as compared with a peripheral portion thereof in response to an increase in the electrode plate BET, and this is considered to be due to the following reason: when the specific additive agent is included, transportation of the additive agent to the central portion becomes slower than that of the solvent or the salt due to an interaction between the surface of the electrode plate and the additive agent. When the electrode plate BET is within the above range, the reaction resistance in the central portion of the electrode assembly tends to be likely to be suppressed from being increased. The electrode plate BET is preferably 2.0 m²/g or more and 3.0 m²/g or less. The electrode plate BET is measured in accordance with a method described in the below-described section “Examples”. The central portion of the electrode assembly may be, for example, a circular region having a diameter of 10 mm around a geometric center of a plane as viewed in the stacking direction (D axis direction in FIG. 1) of the electrode assembly.

When electrode assembly 50 is the wound type, the thickness of negative electrode active material layer 22 represents the total of the thickness(es) of negative electrode active material layer(s) 22 included in stack 40. When electrode assembly 50 is the stacked type, the thickness of negative electrode active material layer 22 represents the total of the thickness(es) of negative electrode active material layer(s) 22 included in electrode assembly 50. For example, when negative electrode active material layers 22 are formed on the both surfaces of negative electrode plate 20, the thickness of negative electrode active material layer 22 represents the total of the thicknesses of negative electrode active material layers 22 on the both surfaces (two surfaces) thereof. Negative electrode active material layer 22 may have a thickness of 100 μm or more and 260 μm or less, may have a thickness of 40 to 80 μm, or may have a thickness of 50 to 70 μm, for example. It should be noted that the thickness of negative electrode active material layer 22 on one surface thereof may be 20 to 40 μm or may be 25 to 35 μm, for example.

Negative electrode active material layer 22 includes negative electrode active material particles. Negative electrode active material layer 22 may consist essentially of the negative electrode active material particles. Each of the negative electrode active material particles may include at least one selected from a group consisting of natural graphite, artificial graphite, silicon, silicon oxide, tin, tin oxide, and Li₄Ti₅O₁₂, for example. The negative electrode active material particle may be a composite particle, for example. The negative electrode active material particle may include, for example, a substrate particle and a coating film. The coating film can coat a surface of the substrate particle. The substrate particle may include natural graphite or the like, for example. The coating film may include, for example, amorphous carbon or the like.

The negative electrode active material layer can include a particle group consisting of negative electrode active material particles. An average sphericity of the particle group is 0.87 or more. When the average sphericity of the particle group is in the above range, the particles are less likely to be collapsed due to compression and a flow path through which the electrolyte solution permeates in the negative electrode plate tends to be likely to become thick. Thus, during permeation of the specific additive agent toward the center of the electrode plate, the permeation is less likely to be affected by the surface of the negative electrode active material layer, with the result that the reaction resistance in the central portion of the electrode assembly tends to be likely to be decreased. The sphericity of the particle group is preferably 0.90 or more, and is normally 1.00 or less. The average sphericity of the particle group is measured in accordance with a method described in the below-described section “Examples”.

An average particle size D50 (hereinafter also referred to as D50) of the particle group consisting of the negative electrode active material particles may be, for example, 10 μm or more and 30 μm or less. Average particle size D50 represents a particle size corresponding to a cumulative particle volume of 50% from the small particle size side with respect to the total particle volume in the volume-based particle size distribution. Average particle size D50 can be measured by a laser diffraction/scattering method.

Negative electrode active material layer 22 may further include a conductive material, a binder, and the like in addition to the negative electrode active material particles. For example, negative electrode active material layer 22 may consist essentially of 0 to 10% of the conductive material in mass fraction, 0.1 to 10% of the binder in mass fraction, and a remainder of the negative electrode active material particles. The conductive material can include any component. The conductive material may include, for example, carbon black, carbon nanotube, or the like. The binder can include any component. The binder may include, for example, at least one selected from a group consisting of carboxymethyl cellulose (CMC) and styrene-butadiene rubber (SBR).

The electrolyte solution is a liquid electrolyte. The electrolyte solution includes a solvent, a lithium salt (hereinafter also referred to as Li salt), and an additive agent. The solvent is aprotic. The solvent can include any component. The solvent may include, for example, at least one selected from a group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The Li salt is dissolved in the solvent. The Li salt may include, for example, at least one selected from a group consisting of LiPF₆. LiBF₄, and LiN(FSO₂)₂. The Li salt may have a molar concentration of, for example, 0.2 to 2.0 M (mol/L).

A content of the additive agent in the electrolyte solution may be, for example, 0.001 mass % or more and 10 mass % or less. The additive agent includes at least one selected from a group consisting of a boron compound having an oxalate group and a compound having a —SO₂F group. Examples of the boron compound having the oxalate group include lithium bis(oxalato)borate (LiBOB) and the like. Examples of the compound having the fluorosulfonyl group (—SO₂F group) include lithium fluorosulfonate (FSO₃Li), lithium bis(fluorosulfonyl)imide, and a compound represented by the following formula:

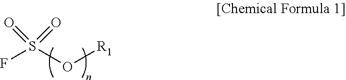

[In the formula, R1 represents an alkyl group, an alkenyl group or an alkynyl group each having 1 to 10 carbon atoms for each of which a halogen atom may substitute, or an aromatic hydrocarbon group having 6 to 20 carbon atoms for each of which a halogen atom may substitute, and n represents an integer of 0 to 1.]

Hereinafter, the present invention will be described in more detail with reference to examples. “%” and “parts” in the examples are mass % and parts by mass unless otherwise stated particularly.

### EXAMPLES

### Example 1

### [Production of Negative Electrode Plate]

Graphite having an average sphericity of 0.9 and an average particle size D50 of 17 μm was used as the negative electrode active material. An active material was selected such that an electrode plate BET of a negative electrode plate became 2.5 m²/g when compressed to a predetermined thickness. A composite material having a composite material composition of graphite:SBR:CMC=100:1:1 wt % was mixed with water to produce a negative electrode composite material slurry, and the negative electrode composite material slurry was applied onto a copper foil of a negative electrode current collector, which was then dried, was compressed to a predetermined thickness, and was cut out to a predetermined width, thereby producing a negative electrode plate constituted of a portion in which the negative electrode active material layer was formed on the copper foil and a portion in which no active material layer was formed thereon. A length of the negative electrode active material layer in a direction parallel to a winding axis direction of the electrode assembly (hereinafter also referred to as a width of the negative electrode active material layer) was 180 mm.

### [Production of Positive Electrode Plate]

A composite material having a composite material composition of LiNiCoMnO₂:AB:PVdF=100:1:1 wt % was mixed with NMP to produce a positive electrode composite material slurry, which was applied onto an aluminum foil of a positive electrode current collector, which was then dried, was compressed to a predetermined thickness, and was cut out to a predetermined width, thereby producing a positive electrode plate constituted of a portion in which a positive electrode active material layer was formed on the aluminum foil in the width direction and a portion in which no active material layer was formed thereon in the width direction. A length of the positive electrode active material layer in the direction parallel to the winding axis direction of the electrode assembly (hereinafter also referred to as a width of the positive electrode active material layer) was 176 mm.

### [Production of Electrode Assembly]

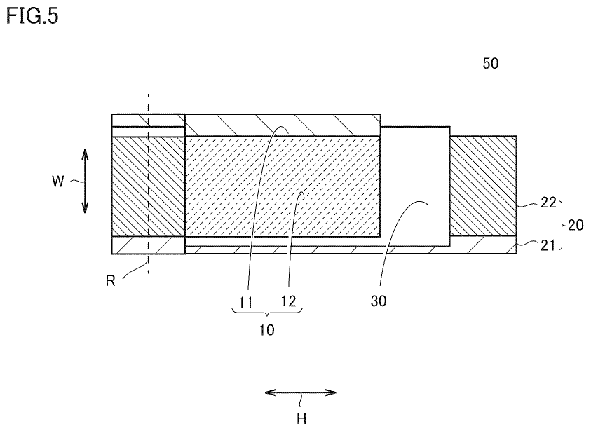

As shown in FIG. 5, a stack was produced by stacking positive electrode plate 10 and negative electrode plate 20 with separator 30, which is composed of three layers of polypropylene/polyethylene/polypropylene, being interposed therebetween such that the aluminum foil of the positive electrode plate and the copper foil of the negative electrode plate were exposed at respective end portions, and the stack was wounded with one end of the stack regarded as a winding axis R, thereby producing a wound type electrode assembly 50.

### [Production of Non-Aqueous Electrolyte Secondary Battery]

The aluminum foil of the positive plate current collecting member and the aluminum plate of the electrode assembly for external current collection were welded to each other, the copper foil of the negative plate current collecting member and the copper plate of the electrode assembly for external current collection were welded to each other, they were inserted into an exterior package of an aluminum laminate film, an electrolyte solution was injected in accordance with the following electrolyte solution injection method, and the laminate film was sealed, thereby producing a non-aqueous electrolyte secondary battery. Results are shown in Table 1.

### [Electrolyte Solution Injection Method]

A first electrolyte solution [1.2M_LiPF₆ EC/EMC (volume ratio of 1:3), and an additive agent: LiBOB_0.5 wt %] was prepared and it was left for 3 hours after injection. Then, charging was performed at a current value of 0.05 C under a 25° C. environment until 2.5 V was attained, and it was left for 1 hour. Next, an activation process was performed.

### Example 2

A non-aqueous electrolyte secondary battery was produced in the same manner as in Example 1 except that instead of using the first electrolyte solution in Example 1, a second electrolyte solution [1.2M_LiPF₆ EC/EMC (volume ratio of 1:3), an additive agent: LiSO₃F_1.0 wt %] was used. Results are shown in Table 1.

### Example 3

A non-aqueous electrolyte secondary battery was produced in the same manner as in Example 1 except that the width of the negative electrode active material layer was 300 mm and the width of the positive electrode active material layer was 296 mm. Results are shown in Table 1.

### Example 4

A non-aqueous electrolyte secondary battery was produced in the same manner as in Example 1 except that graphite having an average particle size D50 of 15 μm and an average sphericity of 0.93 was used as the negative electrode active material, and that the active material was selected such that the electrode plate BET of the negative electrode plate became 2.0 m²/g when compressed to a predetermined thickness. Results are shown in Table 1.

### Example 5

A non-aqueous electrolyte secondary battery was produced in the same manner as in Example 1 except that graphite having an average particle size D50 of 15 μm and an average sphericity of 0.92 was used as the negative electrode active material, and that the active material was selected such that the electrode plate BET of the negative electrode plate became 3.0 m²/g when compressed to a predetermined thickness. Results are shown in Table 1.

### Comparative Example 1

A non-aqueous electrolyte secondary battery was produced in the same manner as in Example 1 except that the width of the negative electrode active material layer was 78 mm and the width of the positive electrode active material layer was 74 mm. Results are shown in Table 1.

### Comparative Example 2

A non-aqueous electrolyte secondary battery was produced in the same manner as in Example 1 except that instead of using the first electrolyte solution in Example 1, a third electrolyte solution [1.2M_LiPF₆ EC/EMC (volume ratio of 1:3), and no additive agent] was used. Results are shown in Table 1.

### Comparative Example 3

A non-aqueous electrolyte secondary battery was produced in the same manner as in Example 1 except that graphite having an average particle size D50 of 14 μm and an average sphericity of 0.86 was used as the negative electrode active material, and that the active material was selected such that the electrode plate BET of the negative electrode plate became 3.0 m²/g when compressed to a predetermined thickness. Results are shown in Table 1.

### Comparative Example 4

A non-aqueous electrolyte secondary battery was produced in the same manner as in Example 1 except that graphite having an average particle size D50 of 25 μm and an average sphericity of 0.92 was used as the negative electrode active material, and that the active material was selected such that the electrode plate BET of the negative electrode plate became 1.7 m²/g when compressed to a predetermined thickness. Results are shown in Table 1.

### Comparative Example 5

A non-aqueous electrolyte secondary battery was produced in the same manner as in Example 1 except that graphite having an average particle size D50 of 14 μm and an average sphericity of 0.90 was used as the negative electrode active material, and that the active material was selected such that the electrode plate BET of the negative electrode plate became 3.5 m²/g when compressed to a predetermined thickness. Results are shown in Table 1.

### <Method of Measuring Electrode Plate BET>

A predetermined weight of each negative electrode plate was punched out, was finely cut, and was introduced into a BET measurement cell. The BET measurement cell was heated to expel adsorption gas, then was immersed in liquid nitrogen and was cooled, P/P₀ was measured from pressure loss through N₂ gas in the cell, and a specific surface area was found in accordance with the following BET formula:

$$\\ P / \{ V ( {P}_{0} - P ) \} = 1 / {V}_{m} C + ( C - 1 ) / {V}_{m} C \times P / {P}_{0}$$

[In the formula, V, P, P₀, Vₘ and C respectively represent a gas adsorption amount, a pressure, a saturated vapor pressure, a monomolecular layer adsorption amount (monomolecular layer adsorption gas amount), and a condensation coefficient of an adsorption molecule when a gas molecule (adsorbate) is adsorbed to a solid surface.]

### <Method of Measuring Average Sphericity>

An image analysis was performed onto a plurality of particles so as to find the sphericity of each particle in accordance with the following formula, and the sphericities of the particles were averaged to obtain an average sphericity:

$$\\ Sphericity = ( \begin{matrix}the peripheral length of a circle \\ corresponding to the area of the particle\end{matrix} ) / the total peripheral length of the particle .$$

### <Volume Capacity Evaluation Method>

Charging was performed at a constant current with ⅓ C until 4.2 V was attained, then constant voltage charging was performed until 0.05 C was attained, and then discharging was performed at a constant current with ⅓ C until 2.5 V was attained. A capacity per volume was calculated by dividing a discharging capacity by the volume of the produced battery. Table 1 shows relative values when the numerical value of Example 1 is regarded as 100.

### <Reaction Resistance Evaluation Method>

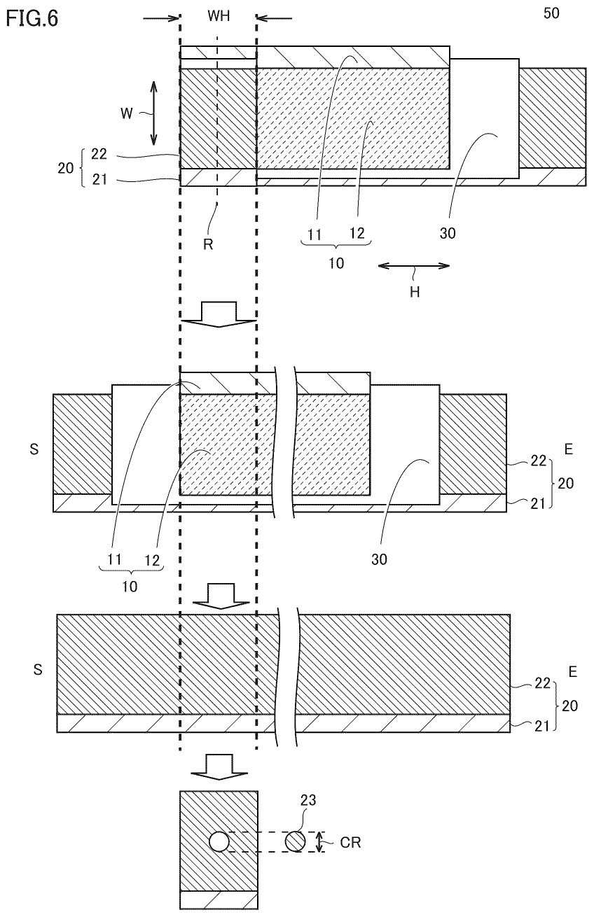

As shown in FIG. 6, the non-aqueous electrolyte secondary battery of each example after the initial activation was disassembled, the negative electrode plate facing the inner peripheral side of the first turn of the positive electrode at the start of winding of the electrode assembly was cut out, was cleaned with dimethyl carbonate (DMC), and was vacuum-dried, and the center of the cut-out negative electrode plate was punched out by φ10 mm (the length of CR in the figure), thereby sampling a reaction resistance evaluation sample 23. One side of the negative electrode was removed and a Li metal having φ11 mm was opposed thereto with a PP/PE/PP separator having φ13 mm being interposed therebetween, thereby producing a coin cell. After the negative electrode of the coin cell was charged to an SOC of 50%, AC impedance was measured in a range of 1 M to 0.1 Hz at a temperature of 25° C. and an amplitude of 10 mV. In the data, a range of 1 khz to 1 Hz was regarded as the reaction resistance. Table 1 shows relative values when the numerical value of Example 1 is regarded as 100.

TABLE 1

| | | | Width of | | | | | |
|---|---|---|---|---|---|---|---|---|
| | | | Negative | | | | | Reaction |
| | | | Electrode | | | | | Resistance |
| | | | Active | Electrode | | | | in Central |
| | | | Material | Plate | | | | Portion of |
| | LiBOB | FSO₃Li | Layer | BET | D50 | | Volume | Electrode |
| | (wt %) | (wt %) | (mm) | (m²/g) | (μm) | Sphericity | Capacity | Plate |
| Example 1 | 0.5 | — | 180 | 2.5 | 17 | 0.91 | 100 | 100 |
| Example 2 | — | 1.0 | 180 | 2.5 | 17 | 0.91 | 101 | 96 |
| Example 3 | 0.5 | — | 300 | 2.5 | 17 | 0.91 | 105 | 121 |
| Example 4 | 0.5 | — | 180 | 2.0 | 15 | 0.93 | 100 | 112 |
| Example 5 | 0.5 | — | 180 | 3.0 | 15 | 0.92 | 100 | 110 |
| Comparative | 0.5 | — | 78 | 2.5 | 17 | 0.91 | 85 | 96 |
| Example 1 | | | | | | | | |
| Comparative | None | None | 180 | 2.5 | 17 | 0.91 | 101 | 131 |
| Example 2 | | | | | | | | |
| Comparative | 0.5 | — | 180 | 3.0 | 14 | 0.86 | 100 | 134 |
| Example 3 | | | | | | | | |
| Comparative | 0.5 | — | 180 | 1.7 | 25 | 0.92 | 99 | 134 |
| Example 4 | | | | | | | | |
| Comparative | 0.5 | — | 180 | 3.5 | 14 | 0.90 | 100 | 124 |
| Example 5 | | | | | | | | |

As shown in Table 1, in each of Examples 1 to 5, it was possible to maintain the volume capacity and suppress an increase in reaction resistance of the central portion of the electrode assembly. An effect of reducing the reaction resistance by using the boron compound (LiBOB) including the oxalate group or the compound (FSO₃Li) including SO₂F was confirmed. Further, it was confirmed that as the width of the negative electrode active material layer is wider, the volume capacity tends to be increased but the reaction resistance in the central portion of the electrode assembly tends to be increased. This is presumably due to the following reason: an interaction occurs between the surface of the negative electrode active material layer and the additive agent to result in slower permeation of the additive agent than that of the solvent or the salt. As a result, it is presumed that a protective coating film formed by the additive agent in the negative electrode active material layer is unevenly present to result in a small amount of the protective coating film in the central portion of the electrode assembly, with the result that the reaction becomes non-uniform to cause the increased reaction resistance.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A non-aqueous electrolyte secondary battery comprising an electrode assembly and an electrolyte solution, wherein
the electrode assembly includes a positive electrode plate, a negative electrode plate, and a separator,
the electrolyte solution includes a solvent, a lithium salt, and an additive agent,
the additive agent includes at least one selected from a group consisting of a boron compound having an oxalate group and a compound having a fluorosulfonyl group,
the negative electrode plate includes a negative electrode core member and a negative electrode active material layer including a negative electrode active material particle,
a BET specific surface area of the negative electrode active material layer is 1.8 m²/g or more and 3.0 m²/g or less,
the negative electrode active material layer includes a particle group consisting of the negative electrode active material particle, and an average sphericity of the particle group is 0.87 or more,
the electrode assembly is a wound type electrode assembly or a stacked type electrode assembly,
when the electrode assembly is the wound type electrode assembly, a length of the negative electrode active material layer in a direction parallel to a winding axis direction of the electrode assembly is 180 mm or more, and
when the electrode assembly is the stacked type electrode assembly, a shortest distance between at least one set of opposing end portions in the negative electrode active material layer as viewed in a stacking direction is 180 mm or more.

2. The non-aqueous electrolyte secondary battery according to claim 1, wherein a size of the electrode assembly in a width direction of the electrode assembly is 300 mm or less.

3. The non-aqueous electrolyte secondary battery according to claim 1, wherein a content of the additive agent in the electrolyte solution is 0.001 mass % or more and 10 mass % or less.

4. The non-aqueous electrolyte secondary battery according to claim 1, wherein an average particle size D50 of the particle group is 10 μm or more and 30 μm or less.

5. The non-aqueous electrolyte secondary battery according to claim 1, wherein the average sphericity is 0.9 or more.
